(19) United States
(12) Patent Application Publication
(10) Pub. No.: US 2026/0121193 A1
(43) Pub. Date: Apr. 30, 2026

(54) BATTERY MODULE AND BATTERY PACK INCLUDING THE SAME

(71) Applicant: SK ON CO., LTD., Seoul (KR)

(72) Inventors: Se Hyeon KIM, Daejeon (KR); Do Yun KWAK, Daejeon (KR); Ji Min KIM, Daejeon (KR); Suk Ho SHIN, Daejeon (KR); Seung Soo CHO, Daejeon (KR)

(21) Appl. No.: 19/317,144

(22) Filed: Sep. 3, 2025

(30) Foreign Application Priority Data
Oct. 28, 2024 (KR) 10-2024-0148810

(51) Int. Cl. H01M 50/244; H01M 10/613; H01M 10/6568; H01M 50/184; H01M 50/186; H01M 50/211; H01M 50/505

(52) U.S. Cl. CPC H01M 50/244; H01M 10/613; H01M 10/6568; H01M 50/184; H01M 50/186; H01M 50/211; H01M 50/505

(57) ABSTRACT

The present disclosure provides a battery module including a cell assembly including a plurality of battery cells; a module case forming an accommodation space accommodating the cell assembly, and including a lower case and an upper case coupled to the lower case; and a side plate disposed between the cell assembly and the module case, wherein the lower case includes a first inner side surface opposing the side plate and having a slope in a first direction, a vertical direction, and a first guide groove recessed on the first inner side surface, and the side plate includes a first guide protrusion inserted into and guided by the first guide groove.

### CROSS-REFERENCE TO RELATED APPLICATION(S)

This patent document claims the priority and benefits of Korean Patent Application No. 10-2024-0148810 filed on Oct. 28, 2024, the disclosure of which may be incorporated herein by reference in its entirety.

### TECHNICAL FIELD

The present disclosure relates to a battery module including a plurality of battery cells (secondary battery cells) capable of being charged with and of discharging electricity, and a battery pack including the same.

### BACKGROUND

Unlike primary batteries, secondary battery cells may charge and discharge electricity, and thus may be applied to devices within various fields such as a digital camera, a mobile phone, a laptop, a hybrid vehicle, and an electric vehicle. For example, secondary battery cells may include a lithium secondary battery, a nickel-cadmium battery, a nickel-metal hydride battery, a nickel-hydrogen battery, or the like.

Such secondary battery cells may be manufactured as a pouch-type cell having flexibility or a can-type cell having rigidity. The can-type cell may be classified as a prismatic cell, a cylindrical cell, a coin-type cell, or the like, depending on an external shape thereof.

A plurality of battery cells may be disposed in a module case to form a battery module. A plurality of battery modules may form a battery pack.

### SUMMARY

A battery module may include a cell assembly including a plurality of battery cells, and a module case accommodating the cell assembly.

The cell assembly may be disposed in an accommodation space of the module case and then fixed to the module case. Since a process of assembling a cell assembly to a module case may include a process of disposing the cell assembly on the module case and a process of fixing the cell assembly to the module case, it may not be easy to assemble the cell assembly and the module case.

In addition, when swelling occurs in a battery cell according to use of the battery module, a large amount of pressure may be applied to a portion of the module case, to deteriorate structural stability of the module case.

In addition, when the cell assembly is mechanically fixed to the module case by bolt fastening or the like, a region for bolt fastening should be formed in the module case, and accordingly, since a sealing member has a complex shape, sealability of the battery module may be impaired.

According to an aspect of the present disclosure, a battery module that may be easy to assemble and a battery pack including the same may be provided.

According to an aspect of the present disclosure, a battery module with improved structural stability and/or rigidity, and a battery pack including the same, may be provided.

According to an aspect of the present disclosure, a battery module having improved sealability and a battery pack including the same may be provided.

A battery module and a battery pack including the same, of the present disclosure, may be widely applied to green technology fields such as that of an electric vehicle, a battery charging station, and, in addition, solar power generation and wind power generation using batteries, or the like. In addition, a battery module and a battery pack including the same, of the present disclosure, may be used in an eco-friendly electric vehicle, a hybrid vehicle, or the like to ameliorate the effects of climate change by suppressing air pollution and greenhouse gas emissions.

A battery module according to the present disclosure includes a cell assembly including a plurality of battery cells; a module case forming an accommodation space accommodating the cell assembly, and including a lower case and an upper case coupled to the lower case; and a side plate disposed between the cell assembly and the module case, wherein the lower case includes a first inner side surface opposing the side plate and having a slope in a first direction, a vertical direction, and a first guide groove recessed on the first inner side surface, and the side plate includes a first guide protrusion inserted into and guided by the first guide groove.

According to an embodiment, a slope of the first inner side surface may have a shape in which a width of the accommodation space decreases in a downward direction, and the first guide groove and the first guide protrusion may have a shape having a slope in the first direction and extending in the downward direction, respectively.

In an embodiment, an angle formed by the first guide groove in the first direction may have a value corresponding to an angle formed by the first guide protrusion in the first direction.

In an embodiment, the first guide groove and the first guide protrusion may have a shape in which a width thereof decreases downward in the first direction, respectively.

In an embodiment, the plurality of battery cells and the side plate may be arranged in a second direction, and the first inner side surface of the lower case may oppose the side plate in the second direction.

In an embodiment, the side plate may further include a first contact protrusion in which at least a portion of the side plate is in contact with the first inner side surface, and having a shape having a slope in the first direction and extending in a downward direction.

In an embodiment, an angle formed by the first inner side surface in the first direction may have a value corresponding to an angle formed by the first contact protrusion in the first direction.

In an embodiment, the side plate may further include a protrusion transverse extending in a direction, intersecting the first direction, and at least a portion of the transverse protrusion may be in contact with the first inner side surface.

In an embodiment, the lower case may further include a lower support portion contacting a lower portion of the side plate and supporting the side plate.

In an embodiment, the upper case may include a second inner side surface opposing the side plate and having a slope in the first direction, and a second guide groove recessed in the second inner side surface, and the side plate may further include a second guide protrusion inserted into and guided by the second guide groove.

In an embodiment, a slope of the second inner side surface may have a shape in which a width of the accommodation space decreases in an upward direction, and the second guide groove and the second guide protrusion may have a shape having a slope in the first direction and extending in the upward direction, respectively.

In an embodiment, an angle formed by the second guide groove in the first direction may have a value corresponding to an angle formed by the second guide protrusion in the first direction.

In an embodiment, the first guide protrusion and the second guide protrusion may have a symmetrical shape with respect to a plane, perpendicular to the first direction.

In an embodiment, the second guide groove and the second guide protrusion may have a shape in which a width thereof decreases upwardly in the first direction, respectively.

In an embodiment, the side plate may further include a second contact protrusion in which at least a portion of the side plate is in contact with the second inner side surface, and having a shape having a slope in the first direction and extending in an upward direction.

In an embodiment, an angle formed by the second inner side surface in the first direction may have a value corresponding to an angle formed by the second contact protrusion in the first direction.

In an embodiment, the side plate may further include a transverse protrusion extending in a direction, intersecting the first direction, and at least a portion of the transverse protrusion may be in contact with the second inner side surface.

In an embodiment, the lower case and the upper case may include a first coupling portion and a second coupling portion, coupled to each other, respectively, a sealing member sealing the accommodation space may be disposed between the first coupling portion and the second coupling portion, and the sealing member may have a tetragonal ring shape having four straight portions extending in a straight line, respectively.

In an embodiment, the battery module may further include a busbar assembly electrically connected to the plurality of battery cells, wherein the cell assembly, the busbar assembly, and the side plate may be integrally coupled to form a sub-module, and the cell assembly and the side plate may be installed in the lower case, in a state in which the sub-module is formed.

In an embodiment, the accommodation space may accommodate a refrigerant contacting the cell assembly to cool the cell assembly, and the module case may further include a refrigerant inlet supplying the refrigerant to the accommodation space, and a refrigerant outlet discharging the refrigerant from the accommodation space.

A battery module of the present disclosure includes a cell assembly including a plurality of battery cells; a module case forming an accommodation space accommodating the cell assembly, and including a lower case and an upper case coupled to the lower case; and a side plate disposed between the cell assembly and the module case, wherein at least one of the lower case or the upper case includes an inner side surface having a slope in a first direction, a vertical direction, and a guide groove recessed on the inner side surface, and the side plate includes a guide protrusion inserted into and guided by the guide groove.

A battery pack of the present disclosure includes a plurality of battery modules; and a pack housing including a module accommodation space accommodating the plurality of battery modules, wherein at least one battery module among the plurality of battery modules includes a cell assembly including a plurality of battery cells; a module case forming an accommodation space accommodating the cell assembly, and including a lower case and an upper case coupled to the lower case; and a side plate disposed between the cell assembly and the module case, wherein the lower case includes a first inner side surface opposing the side plate and having a slope in a first direction, a vertical direction, and a first guide groove recessed on the first inner side surface, and the side plate includes a first guide protrusion inserted into and guided by the first guide groove.

### BRIEF DESCRIPTION OF DRAWINGS

Certain aspects, features, and advantages of the present disclosure may be illustrated by the following detailed description with reference to the accompanying drawings.

FIG. 1 is a perspective view of a battery module according to an embodiment.

FIG. 2 is an exploded perspective view of the battery module illustrated in FIG. 1.

FIG. 3 is a perspective view illustrating a sub-module in the battery module illustrated in FIG. 1.

FIG. 4 is a front view of a side plate according to an embodiment.

FIG. 5 is a cross-sectional view of the guide protrusion of FIG. 4, taken along line I-I′.

FIG. 6 is a cross-sectional view of the contact protrusion of FIG. 4, taken along line II-II′.

FIG. 7 is a perspective view of a lower case according to an embodiment.

FIG. 8 is a perspective view illustrating an upper case according to an embodiment, inverted vertically.

FIG. 9 is a cross-sectional view illustrating a state before assembly of the lower case, the sub-module, and the upper case of FIG. 1, taken along line III-III′.

FIG. 10 is a cross-sectional view illustrating a state in which the sub-module is coupled to the lower case in FIG. 9.

FIG. 11 is a cross-sectional view illustrating a state in which the upper case is coupled to the sub-module in FIG. 9.

FIG. 12 is a cross-sectional view of a portion of the lower case of FIG. 1, taken along line IV-IV′.

FIG. 13 is a perspective view of a battery pack according to an embodiment.

### DETAILED DESCRIPTION

Hereinafter, the present disclosure will be described in detail with reference to the attached drawings. However, this may be merely an example, and the present disclosure may not be limited to the specific embodiments described by manner of example.

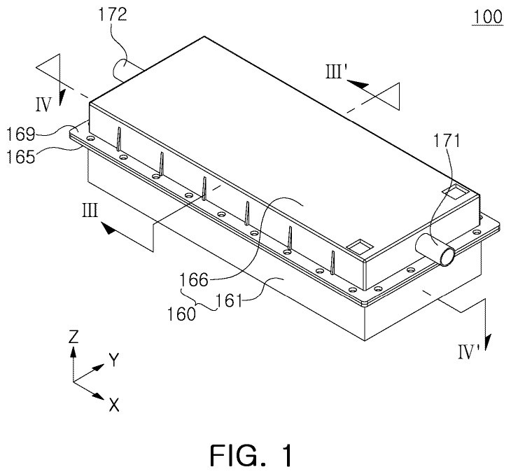

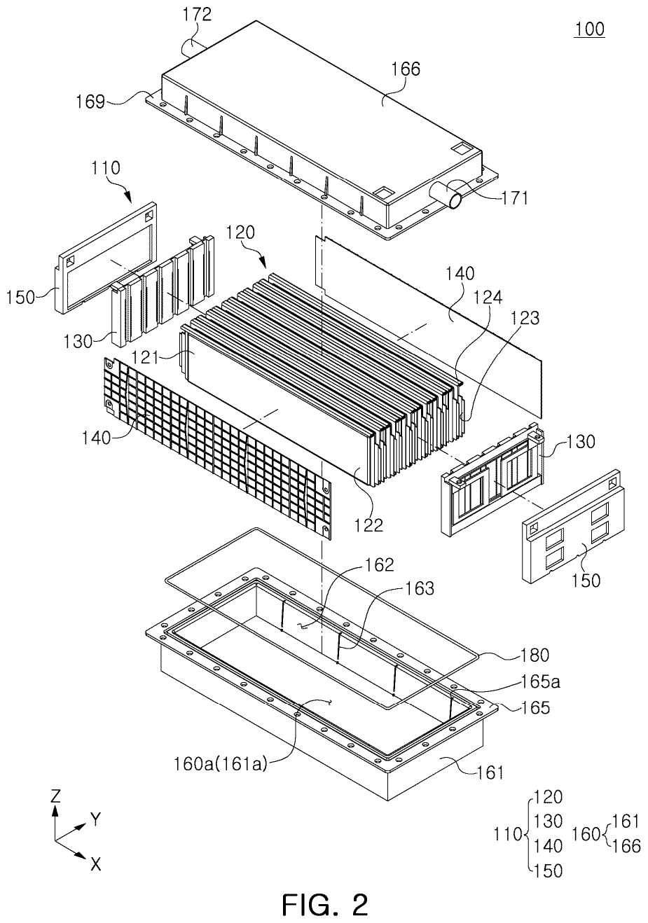

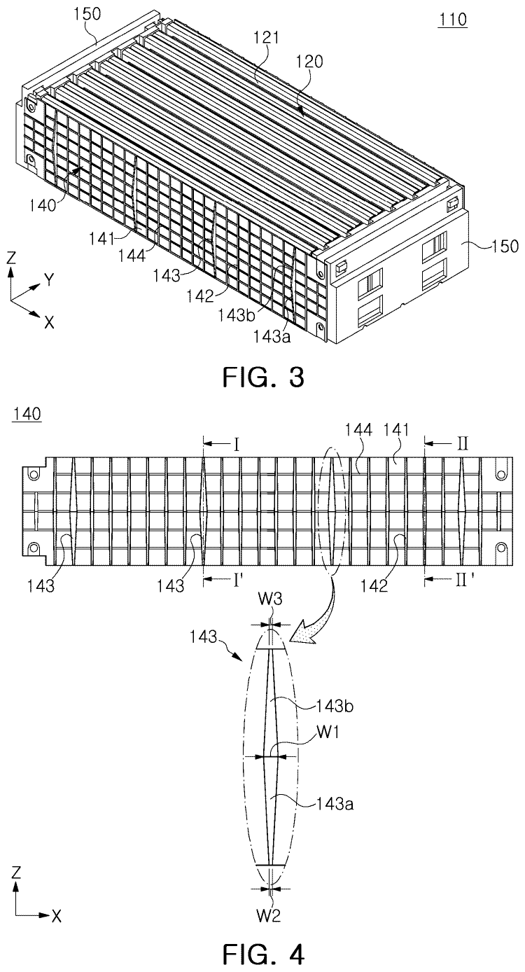

FIG. 1 is a perspective view of a battery module 100 according to an embodiment. FIG. 2 is an exploded perspective view of the battery module 100 illustrated in FIG. 1. FIG. 3 is a perspective view illustrating a sub-module in the battery module 100 illustrated in FIG. 1.

A battery module 100 according to an embodiment may include a cell assembly 120 including a plurality of battery cells 121, a module case 160 forming an accommodation space 160a for accommodating the cell assembly 120, and including a lower case 161 and an upper case 166 coupled to the lower case 161, and a side plate 140 disposed between the cell assembly 120 and the module case 160. The lower case 161 may include a first inner side surface 162 opposing the side plate 140 and having a slope in a first direction Z, which is a vertical direction, and a first guide groove 163 recessed on the first inner side surface 162. The side plate 140 may include a first guide protrusion 143a inserted into and guided by the first guide groove 163.

At least one of the lower case 161 or the upper case 166 may include an inner side surface having a slope in the first direction Z, which may be a vertical direction, and a guide groove recessed on the inner side surface, and the side plate 140 may include a guide protrusion inserted into and guided by the guide groove.

The cell assembly 120 may include the plurality of battery cells 121. As an example, the battery cells 121 may include a pouch-type cell. The plurality of battery cells 121 may be arranged in a second direction Y, but an arrangement direction or an arrangement structure of the battery cells 121 may be variously changed.

In the present disclosure, a type of a battery cell 121 is not limited to a pouch-type cell, and may also include a prismatic cell or a cylindrical cell. Hereinafter, for convenience of explanation, the battery cell 121 will be described using the pouch-type cell as an example.

The battery cell 121 may include an electrode assembly accommodated in a cell casing 122 having a pouch shape, and an electrode lead 123 electrically connected to the electrode assembly.

The electrode assembly may include a positive plate, a negative plate, and a separator. The cell casing 122 may surround the electrode assembly, and may have a shape corresponding to the electrode assembly. At least a portion of a periphery of the cell casing 122 may be sealed. A portion of a sealed portion of the cell casing 122 may be bent to form a bent portion 124.

The electrode lead 123 may be exposed to an external space of the cell casing 122. The electrode lead 123 may include a positive electrode lead connected to the positive plate, and a negative electrode lead connected to the negative plate. The electrode leads 123 may be disposed on both sides in a third direction X which may be a length direction of the cell casing 122. For example, the positive electrode lead and the negative electrode lead may be disposed on one side and the other side in the length direction of the cell casing 122, respectively. Although FIG. 2 illustrates a structure in which electrode leads 123 are disposed on both sides of the cell casing 122, one by one, arrangement and the number of the electrode leads 123 may be changed in various manners.

The battery cell 121 may have a shape in which a length of the cell casing 122 may be greater than a height of the cell casing 122. The length of the cell casing 122 is a value measured along an X direction, and the height of the cell casing 122 is a value measured along a Y direction. To increase an energy density of the battery cell 121, the length of the cell casing 122 may be more than twice the height of the cell casing 122. However, the shape of the cell casing 122 may be changed in various manners.

The module case 160 may form the accommodation space 160a accommodating the cell assembly 120. The module case 160 may include the lower case 161 and the upper case 166 coupled to the lower case 161.

The lower case 161 may form a lower accommodation space 161a. The lower case 161 may include the first inner side surface 162 and the first guide groove 163, opposing the side plate 140.

The first inner side surface 162 may have a predetermined slope. The first inner side surface 162 may have a slope in the first direction Z, which may be a vertical direction.

The slope of the first inner side surface 162 may have a shape in which a width of the accommodation space 160a decreases in a downward direction. The slope of the first inner side surface 162 may have a shape in which a width of the accommodation space 160a becomes narrower from an upper side to a lower side in the accommodation space 160a. The first inner side surface 162 may have a slope facing an inner side of the accommodation space 160a in the downward direction.

The first guide groove 163 may be recessed in the first inner side surface 162. The first guide groove 163 may be formed in plural in the first inner side surface 162.

The upper case 166 may be coupled to the lower case 161 in an upper portion of the lower case 161. The upper case 166 may cover the lower case 161 in a state in which the cell assembly 120 and the side plate 140 are accommodated in the lower case 161.

The lower case 161 and the upper case 166 may include a first coupling portion 165 and a second coupling portion 169, coupled to each other, respectively. The first coupling portion 165 may have a shape bent on an upper side of the lower case 161 and extending outwardly. The second coupling portion 169 may have a shape bent on a lower side of the upper case 166 and extending outwardly. The first coupling portion 165 and the second coupling portion 169 may include a flat contact surface contacting each other.

A sealing member 180 sealing the accommodation space 160a may be disposed between the first coupling portion 165 and the second coupling portion 169.

The first coupling portion 165 may include a first accommodation groove 165a in which a lower portion of the sealing member 180 is seated, and the second coupling portion 169 may include a second accommodation groove 169a accommodating an upper portion of the sealing member 180. The first accommodation groove 165a and the second accommodation groove 169a may have a cross-sectional shape corresponding to a cross-sectional shape of the sealing member 180.

The sealing member 180 may have a tetragonal ring shape having four straight portions extending in a straight line, respectively. The sealing member 180 may form a tetragon on a plane on which the first coupling portion 165 and the second coupling portion 169 are in contact with each other. The sealing member 180 may have a shape in which a corner is rounded in the tetragon having four vertices. Each side of the sealing member 180 may have a shape extending in a straight line. For example, each side of the sealing member 180 may not include a bypass region for avoiding a specific region. Therefore, the sealing member 180 may improve sealability between the lower case 161 and the upper case 166. According to an embodiment, it is possible to prevent a refrigerant included in the accommodation space from leaking to an external space through a boundary between the lower case 161 and the upper case 166.

The side plate 140 may include a guide protrusion 143 inserted into the first guide groove 163. The guide protrusion 143 may include a first guide protrusion 143a opposing the lower case 161, and a second guide protrusion 143b opposing the upper case 166. The first guide protrusion 143a may have a shape having a slope in the first direction Z and extending downward. The second guide protrusion 143b may have a shape having a slope in the first direction Z and extending upward.

The guide protrusion 143 may be formed on a body 141 of the side plate 140, and may have a shape protruding toward the inner side surface of the module case 160. The guide protrusion 143 may be formed in plural on the body 141 of the side plate 140.

When the side plate 140 is coupled to the lower case 161, the first guide protrusion 143a of the side plate 140 may be inserted into the first guide groove 163 of the lower case 161. The side plate 140 may be coupled to the lower case 161 while the first guide protrusion 143a is inserted into and guided by the first guide groove 163.

The side plate 140 may further include a contact protrusion 142. The contact protrusion 142 may be formed on the body 141 of the side plate 140, and may have a shape protruding toward the inner side surface of the module case 160. At least a portion of the contact protrusion 142 may be configured to contact the inner side surface of the module case 160.

The side plate 140 may further include a transverse protrusion 144 extending in a direction, intersecting the first direction Z. The transverse protrusion 144 may be formed on the body 141 of the side plate 140, and may have a shape protruding toward the inner side surface of the module case 160. At least a portion of the transverse protrusion 144 may be configured to contact the inner side surface of the module case 160.

The plurality of battery cells 121 and the side plates 140 may be arranged in the second direction Y. The plurality of battery cells 121 may be arranged in the second direction Y. The plurality of battery cells 121 may be stacked in the second direction Y to form the cell assembly 120. The side plates 140 may be disposed on both sides of the cell assembly 120 in the second direction Y, respectively. The side plates 140 may be disposed on one side and the other side of the cell assembly 120 in the second direction Y, respectively.

The first inner side surface 162 of the lower case 161 may oppose the side plate 140 in the second direction Y. The side plates 140 disposed on each of the both sides of the cell assembly 120 may face the first inner side surface 162 of the lower case 161, respectively. The lower case 161 may include a pair of first inner side surfaces 162 opposing each other, and an accommodation space 160a may be formed between the pair of first inner side surfaces 162. The pair of first inner side surfaces 162 may face each other, with the cell assembly 120 and the side plate 140 interposed therebetween.

A battery module 100 according to an embodiment may be configured as a battery module for refrigerant immersion in which a refrigerant (a medium for cooling, a cooling fluid) for cooling the battery cell 121 is supplied to the accommodation space 160a. In the battery module 100 for refrigerant immersion, a refrigerant contacting the cell assembly 120 to cool the cell assembly 120 may be accommodated in the accommodation space 160a. The refrigerant supplied to the accommodation space 160a may cool the battery cell 121 by directly contacting the battery cell 121 and the refrigerant. However, the battery module 100 of the present disclosure is not limited to the battery module for refrigerant immersion.

The refrigerant may include an insulating oil. The cell assembly 120 may be immersed in the refrigerant. In an embodiment, the refrigerant may be a fluid acting as an electrical insulator. For example, the refrigerant may include an insulating oil having a non-conductive oil as a main component thereof. The refrigerant may be changed to another fluid when cooling of the battery module 100 is possible.

The module case 160 may further include a refrigerant inlet 171 supplying the refrigerant to the accommodation space 160a, and a refrigerant outlet 172 discharging the refrigerant from the accommodation space 160a.

The refrigerant inlet 171 may supply the refrigerant having a low temperature for cooling the battery cells 121 to the accommodation space 160a, and the refrigerant outlet 172 may discharge the refrigerant having an increased temperature by heat exchange with the battery cells 121, to an external space of the accommodation space 160a. Although FIGS. 1 and 2 illustrate a structure in which the refrigerant inlet 171 and the refrigerant outlet 172 are disposed in the upper case 166, arrangement of the refrigerant inlet 171 and the refrigerant outlet 172 is not limited thereto.

A battery module 100 according to an embodiment may further include a busbar assembly 130 electrically connected to a plurality of battery cells 121. The busbar assembly 130 may include a busbar formed of an electrically conductive material electrically connected to the plurality of battery cells 121, and a busbar support portion formed of an electrically insulating material supporting the busbar.

A battery module 100 according to an embodiment may further include an insulating cover 150 disposed between the busbar assembly 130 and the module case 160. The insulating cover 150 may be formed of an electrically insulating material, and may insulate between the busbar assembly 130 and the module case 160. The insulating cover 150 may protect the busbar assembly 130.

The cell assembly 120, the busbar assembly 130, and the side plate 140 may be integrally coupled to form a sub-module 110. The sub-module 110 may include the cell assembly 120, the busbar assembly 130, and the side plate 140. The sub-module 110 may further include the insulating cover 150. The busbar assembly 130, the side plate 140, and the insulating cover 150 may be integrally coupled by bolt fastening or the like.

The cell assembly 120 and the side plate 140 may be installed in the lower case 161 in a state in which the sub-module 110 is formed. Therefore, when the cell assembly 120 and the side plate 140 form the sub-module 110, the battery module 100 may be easily assembled.

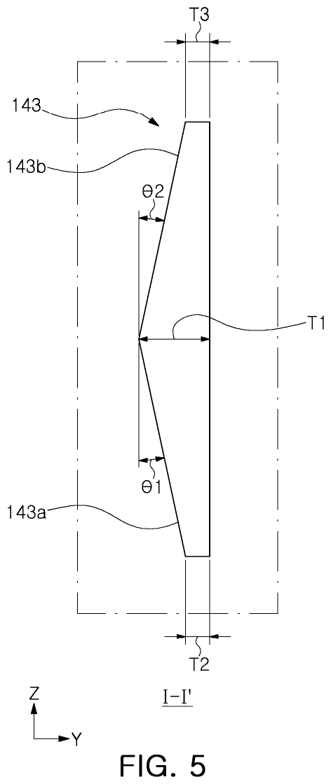

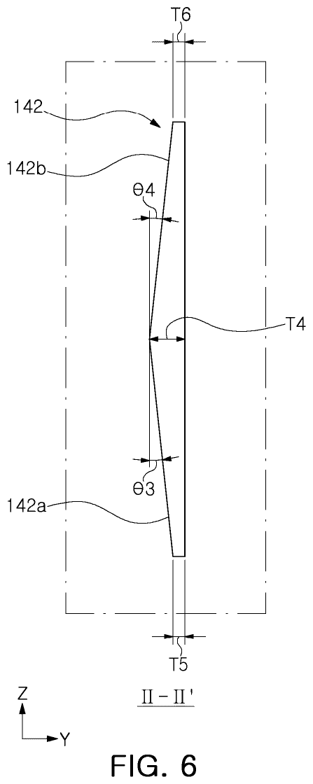

FIG. 4 is a front view of a side plate 140 according to an embodiment. FIG. 5 is a cross-sectional view of the guide protrusion 143 of FIG. 4, taken along line I-I′. FIG. 6 is a cross-sectional view of the contact protrusion 142 of FIG. 4, taken along line II-II′.

A side plate 140 will be described with reference to FIGS. 4 to 6 together with FIGS. 2 and 3.

The side plate 140 may include a guide protrusion 143. The guide protrusion 143 may include a first guide protrusion 143a facing a lower case 161, and a second guide protrusion 143b facing an upper case 166. The guide protrusion 143 may be formed on a body 141 of the side plate 140, and may have a shape protruding toward an inner side surface of a module case 160. The guide protrusion 143 may be formed in plural on the body 141 of the side plate 140.

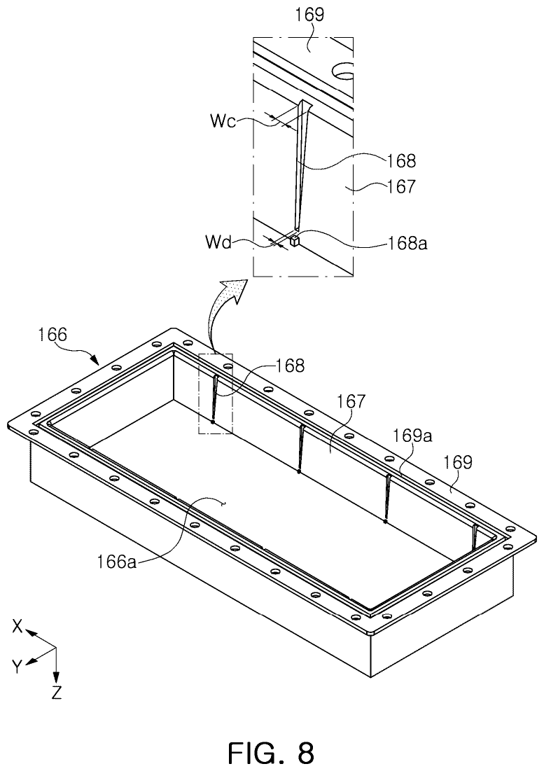

The first guide protrusion 143a may be inserted into and guided by a first guide groove 163 of the lower case 161. The second guide protrusion 143b may be inserted into and guided by a second guide groove (168 of FIG. 8) of the upper case 166.

A width of the guide protrusion 143 may be changed depending on a height of the guide protrusion 143 in the first direction Z. The width of the guide protrusion 143 may be defined as a value measured in the third direction X.

The first guide protrusion 143a may have a shape in which a width decreases downward in the first direction Z. For example, the first guide protrusion 143a may have a width W2 on a lower side, smaller than a width W1 on an upper side. In this case, when the side plate 140 is coupled to the lower case 161, the first guide protrusion 143a may be easily inserted into and guided by the first guide groove 163. Therefore, assembly of the side plate 140 and the cell assembly 120 coupled thereto may be easily performed.

The second guide protrusion 143b may have a shape in which a width decreases upwardly in the first direction Z. For example, the second guide protrusion 143b may have a width W3 on an upper side, smaller than a width W1 on a lower side. In this case, when the upper case 166 is coupled to the side plate 140, the second guide protrusion 143b may be easily inserted into and guided by the second guide groove 168. Therefore, assembly of the upper case 166 may be easily performed.

The first guide protrusion 143a and the second guide protrusion 143b may have a symmetrical shape with respect to a plane (X-Y plane), perpendicular to the first direction Z. For example, the first guide protrusion 143a and the second guide protrusion 143b may have a symmetrical shape with respect to each other with respect to a center. The side plate 140 may have an overall symmetrical shape with respect to the center. In this manner, when the first guide protrusion 143a and the second guide protrusion 143b have the symmetrical shape or the side plate 140 has the overall symmetrical shape, pressure due to swelling of the battery cell 121 may be uniformly transmitted to the module case 160 through the side plate 140. Therefore, structural stability and rigidity of the battery module 100 may be improved.

The first guide protrusion 143a may have a shape having a slope in the first direction Z and extending in a downward direction.

An angle θ1 formed by the first guide protrusion 143a in the first direction Z may have a value corresponding to an angle formed by the first guide groove 163 in the first direction Z. In the present disclosure and claims, the meaning of ‘corresponding to an angle’ may include not only a case in which angles of both are the same, but also a case in which angles of both have substantially the same angles in considering tolerance or the like. For example, when a difference in angle between objects to be compared is less than 1 degree, it may be defined as having an angle corresponding thereto.

In the second direction Y, the first guide protrusion 143a may have a thickness T2 on a lower side, smaller than a thickness T1 on an upper side.

The second guide protrusion 143b may have a shape having a slope in the first direction Z and extending in an upward direction.

An angle θ2 formed by the second guide protrusion 143b in the first direction Z may have a value corresponding to an angle formed by the second guide groove 168 in the first direction Z.

In FIG. 5, a slope is illustrated as being formed entirely over a height of the first guide protrusion 143a and a height of the second guide protrusion 143b, but the first guide protrusion 143a and the second guide protrusion 143b may also include a portion partially parallel to the first direction Z. For example, the first guide protrusion 143a and the second guide protrusion 143b may include a portion parallel to the first direction Z in a boundary portion therebetween.

The side plate 140 may include a contact protrusion 142 in which at least a portion of the side plate 140 is in contact with an inner side surface of the module case 160. The contact protrusion 142 may include a first contact protrusion 142a facing the lower case 161, and a second contact protrusion 142b facing the upper case 166.

In the second direction Y, the second guide protrusion 143b may have a thickness T3 on an upper side smaller than a thickness T1 on a lower side.

At least a portion of the first contact protrusion 142a may be in contact with a first inner side surface 162 of the lower case 161. The first contact protrusion 142a may have a shape having a slope in the first direction Z and extending in a downward direction.

An angle θ3 formed by the first contact protrusion 142a in the first direction Z may correspond to an angle θa formed by the first inner side surface 162 of the lower case 161 in the first direction Z. Therefore, the first contact protrusion 142a may be in contact with the first inner side surface 162 of the lower case 161.

In the second direction Y, the first contact protrusion 142a may have a thickness T5 on a lower side, smaller than a thickness T4 on an upper side.

At least a portion of the second contact protrusion 142b may be in contact with a second inner side surface (167 of FIG. 8) of the upper case 166. The second contact protrusion 142b may have a shape having a slope in the first direction Z and extending in an upward direction.

An angle θ4 formed by the second contact protrusion 142b in the first direction Z may correspond to an angle θb formed by the second inner side surface 167 of the upper case 166 in the first direction Z. Therefore, the second contact protrusion 142b may be in contact with the second inner side surface 167 of the upper case 166.

In the second direction Y, the second contact protrusion 142b may have a thickness T6 on an upper side, smaller than a thickness T4 on a lower side.

In the second direction Y, a thickness of the guide protrusion 143 may have a value greater than a thickness of the contact protrusion 142. For example, since the first guide protrusion 143a may be inserted into the first guide groove 163 and the second guide protrusion 143b may be inserted into the second guide groove 168, a thickness of the guide protrusion 143 may have a value greater than a thickness of the contact protrusion 142 by a depth of a portion inserted into a guide groove.

Based on the first direction Z, the angle θ1 formed by the first guide protrusion 143a, the angle θ3 formed by the first contact protrusion 142a, the angle θa formed by the first inner side surface 162, and the angle formed by the first guide groove 163 may have values corresponding to each other. Based on the first direction Z, the angle θ2 formed by the second guide protrusion 143b, the angle θ4 formed by the second contact protrusion 142b, the angle θb formed by the second inner side surface 167, and the angle formed by the second guide groove 168 may have values corresponding to each other.

When the contact protrusion 142 is in contact with the module case 160, pressure due to swelling of the battery cell 121 may be uniformly transmitted to the module case 160 through the side plate 140. Therefore, structural stability and rigidity of the battery module 100 may be improved.

In FIG. 6, a slope is illustrated as being formed entirely over a height of the first contact protrusion 142a and a height of the second contact protrusion 142b, but the first contact protrusion 142a and the second contact protrusion 142b may also include a portion partially parallel to the first direction Z. For example, the first contact protrusion 142a and the second contact protrusion 142b may include a portion parallel to the first direction Z in a boundary portion therebetween.

The side plate 140 may further include a transverse protrusion 144 extending in a direction, intersecting the first direction Z. As an example, the transverse protrusion 144 may extend in the third direction X, perpendicular to the first direction Z and the second direction Y. The third direction X may be defined as a direction, perpendicular to the first direction Z and the second direction Y. The transverse protrusion 144 may form a lattice shape, together with the guide protrusion 143 and/or the contact protrusion 142.

The transverse protrusion 144 may be formed on the body 141 of the side plate 140, and may have a shape protruding toward the inner side surface of the module case 160. The transverse protrusion 144 may be configured such that at least a portion thereof is in contact with the inner side surface of the module case 160.

At least a portion of the transverse protrusion 144 opposing the lower case 161 may be in contact with the first inner side surface 162 of the lower case 161. At least a portion of the transverse protrusion 144 opposing the upper case 166 may be in contact with the second inner side surface 167 of the upper case 166.

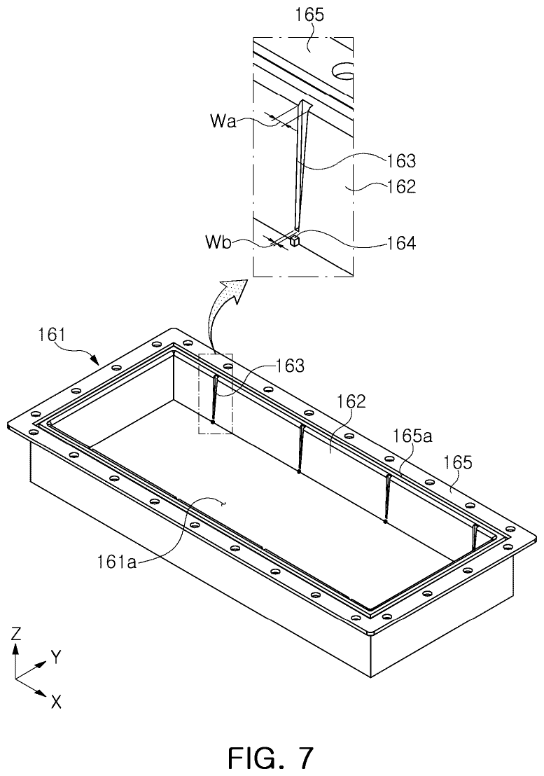

FIG. 7 is a perspective view of a lower case 161 according to an embodiment. FIG. 8 is a perspective view illustrating an upper case 166 according to an embodiment, inverted vertically.

A lower case 161 may form a lower accommodation space 161a therein. The lower case 161 may include a first inner side surface 162 having a slope, and a first guide groove 163 recessed on the first inner side surface 162.

A first guide protrusion 143a of a side plate 140 may be inserted into the first guide groove 163. The first guide protrusion 143a may be inserted into and guided by the first guide groove 163.

A width of a guide groove in the first direction Z may be changed, depending on a height of the guide groove in the first direction Z. The width of the guide groove may be defined as a value measured in the third direction X.

As described with reference to FIG. 4, the first guide protrusion 143a of the side plate 140 may have a shape in which a width decreases downward in the first direction Z. Corresponding thereto, the first guide groove 163 may have a shape in which a width decreases downward in the first direction Z. For example, the first guide groove 163 may have a width Wb on a lower side, smaller than a width Wa on an upper side. The first guide groove 163 and the first guide protrusion 143a may have a shape in which a width decreases downward in the first direction Z.

In this case, when the side plate 140 is coupled to the lower case 161, the first guide protrusion 143a may be easily inserted into and guided by the first guide groove 163. Therefore, assembly of the side plate 140 and a cell assembly 120 coupled thereto may be easily performed.

A slope of the first inner side surface 162 may have a shape in which a width of an accommodation space 160a decreases in a downward direction. The first guide groove 163 may have a slope in the first direction Z, and may extend downward. An angle formed by the first guide groove 163 in the first direction Z may correspond to an angle θ1 formed by the first guide protrusion 143a. The angle formed by the first guide groove 163 in the first direction Z may have a value corresponding to an angle θa formed by the first inner side surface 162.

The lower case 161 may further include a lower support portion 164 contacting a lower portion of the side plate 140 and supporting the side plate 140. The lower support portion 164 may function as a stopper to prevent the side plate 140 from moving downward any further. The side plate 140 may be supported by the lower support portion 164, and may be thus stably installed in the lower case 161.

The lower case 161 may include a first coupling portion 165 to be coupled to a second coupling portion 169 of an upper case 166. The first coupling portion 165 may have a shape bent from an upper portion of the lower case 161 and extending in an outward direction. The first coupling portion 165 may include a first accommodation groove 165a on which a sealing member 180 is seated.

The upper case 166 may form an upper accommodation space 166a therein. The upper case 166 may include a second inner side surface 167 opposing the side plate 140 and having a slope in the first direction Z, and a second guide groove 168 recessed on the second inner side surface 167. Corresponding thereto, the side plate 140 may include a second guide protrusion 143b inserted into and guided by the second guide groove 168.

The upper case 166 may include the second inner side surface 167 having a slope, and the second guide groove 168 recessed on the second inner side surface 167.

The second guide protrusion 143b of the side plate 140 may be inserted into the second guide groove 168. The second guide protrusion 143b may be inserted into the second guide groove 168. When the upper case 166 is coupled to the lower case 161 in a state in which the side plate 140 is disposed, the upper case 166 may move downward as the second guide groove 168 and the second guide protrusion 143b are coupled to each other.

As described with reference to FIG. 4, the second guide protrusion 143b of the side plate 140 may have a shape in which a width thereof decreases upwardly in the first direction Z. Corresponding thereto, the second guide groove 168 may have a shape in which a width thereof decreases upwardly in the first direction Z. For example, the second guide groove 168 may have a width Wd on an upper side, smaller than in a width Wc on a lower side. For example, the second guide groove 168 and the second guide protrusion 143b may have a shape in which a width thereof decreases upwardly in the first direction Z.

In this case, when the upper case 166 is coupled to the side plate 140 and the cell assembly, the second guide protrusion 143b may be easily inserted into and guided by the second guide groove 168. Therefore, assembly of the upper case 166 may be easily performed.

A slope of the second inner side surface 167 may have a shape in which the width of the accommodation space 160a decreases in an upward direction. The second guide groove 168 may have a slope in the first direction Z, and may extend upward. An angle formed by the second guide groove 168 in the first direction Z may correspond to an angle θ2 formed by the second guide protrusion 143b. The angle formed by the second guide groove 168 in the first direction Z may have a value corresponding to an angle θb formed by the second inner side surface 167.

The upper case 166 may further include an upper support portion 168a contacting an upper portion of the side plate 140 and supporting the side plate 140. The upper support portion 168a may function as a pressing member to prevent the side plate 140 from moving upward. The side plate 140 may be pressed by the upper support portion 168a to maintain a stable position in the upper case 166.

The upper case 166 may include a second coupling portion 169 coupled to the first coupling portion 165 of the lower case 161. The second coupling portion 169 may have a shape bent from a lower side of the upper case 166 and extending outward. The second coupling portion 169 may include a second accommodation groove 169a in which the sealing member 180 may be seated.

The upper case 166 may have a shape and size that may be substantially symmetrical to the lower case 161, based on a plane formed by the first contact portion. However, some components of the lower case 161 and the upper case 166 may have different shapes or structures. For example, some components such as a refrigerant inlet 171, a refrigerant outlet 172, or the like may not have a symmetrical structure.

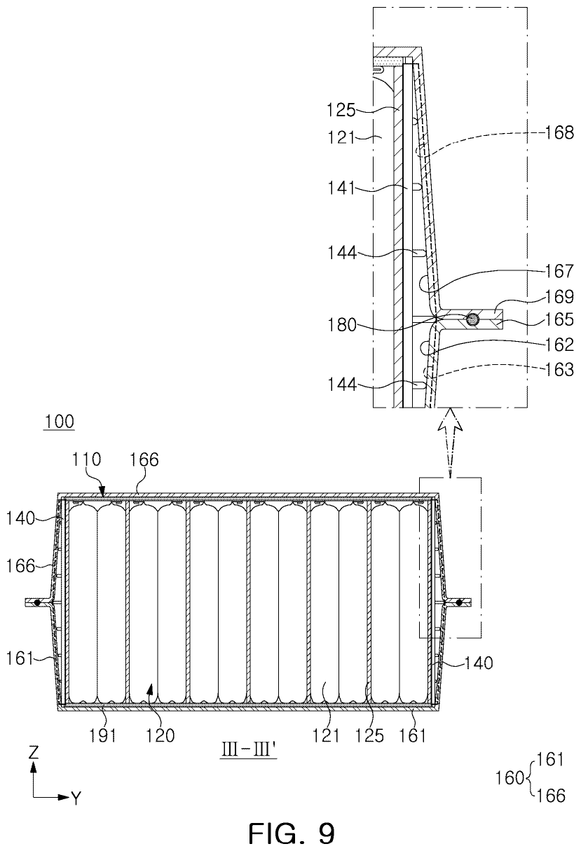

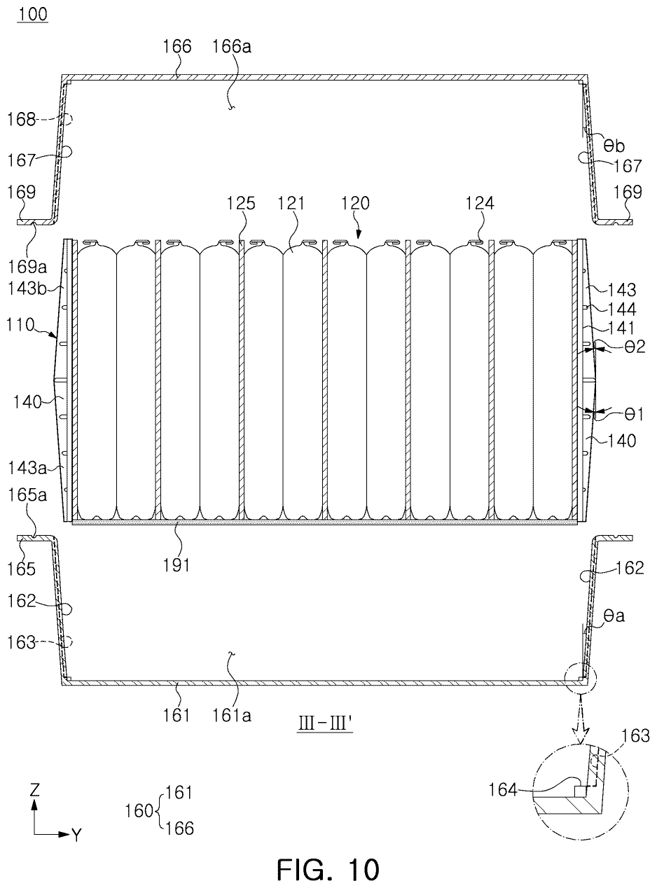

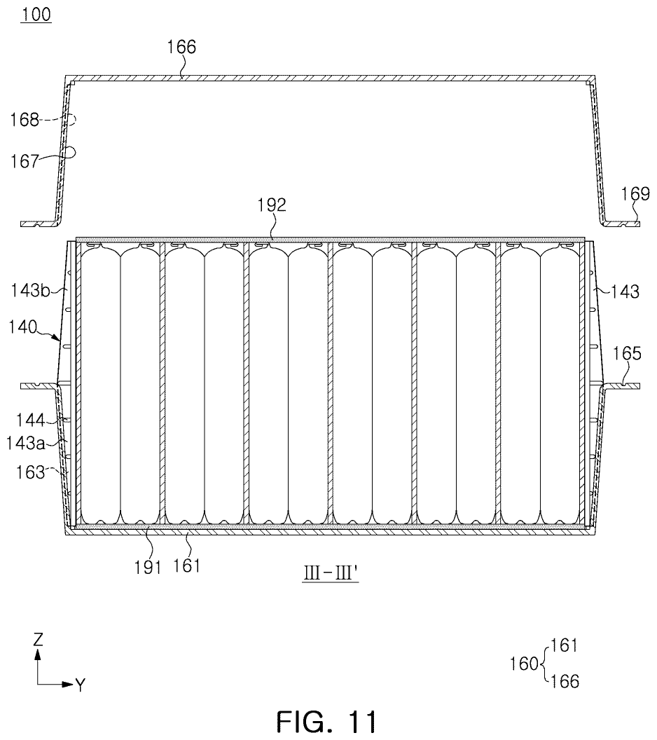

FIG. 9 is a cross-sectional view illustrating a state before assembly of the lower case 161, the sub-module 110, and the upper case 166 of FIG. 1, taken along line III-III′. FIG. 10 is a cross-sectional view illustrating a state in which the sub-module 110 is coupled to the lower case 161 in FIG. 9. FIG. 11 is a cross-sectional view illustrating a state in which the upper case 166 is coupled to the sub-module 110 in FIG. 9.

FIG. 9 illustrates a state in which the lower case 161, the sub-module 110, and the upper case 166 are separated from each other.

The cell assembly 120 and the side plate 140 may be coupled to each other to form the sub-module 110. The cell assembly 120 and the side plate 140 may be installed in the lower case 161 while forming the sub-module 110. The plurality of battery cells 121 and the side plate 140 may be arranged in the second direction Y.

The cell assembly 120 may include a plurality of battery cells 121 and an intervening member 125 disposed between at least a portion of the battery cells 121 among the plurality of battery cells 121. The intervening member may be disposed between the battery cells 121 to perform a preset function. For example, the intervening member may include at least a portion of a compressible pad, a heat dissipation member, or a heat transfer blocking member.

The compressible pad may be compressed when the battery cell 121 expands due to a swelling phenomenon. The compressible member may absorb an expanded thickness of the battery cell 121 to prevent the battery module 100 from being severely deformed.

The heat dissipation member may transfer heat generated from the battery cell 121 to an adjacent other configuration. For example, the heat dissipation member may transfer heat generated from the battery cell 121 to the lower case 161 through a first heat transfer member 191. When the accommodation space 160a is filled with a refrigerant and the cell assembly 120 is in contact with the refrigerant, the heat dissipation member may transfer heat generated from the battery cell 121 to the refrigerant.

The heat transfer blocking member may block heat from being transferred to an adjacent battery cell 121 when a temperature of a portion of the battery cells 121 rapidly increases. The heat transfer blocking member may include a material having at least one or more properties among flame retardancy, heat resistance, or insulation.

The first inner side surface 162 of the lower case 161 may have a slope. The slope of the first inner side surface 162 may have a shape in which a width of the accommodation space 160a decreases in a downward direction. The slope of the first inner side surface 162 may have a shape in which a width of the accommodation space 160a becomes narrower from an upper side to a lower side in the accommodation space 160a. For example, the lower accommodation space 161a of the lower case 161 may have a shape in which a lower side is narrower than an upper side.

The first guide groove 163 and the first guide protrusion 143a may have a shape having a slope in the first direction Z and extending downward, respectively. The slope of the first guide groove 163 and the slope of the first guide protrusion 143a may correspond to a slope of the first inner side surface 162, respectively.

An angle formed by the first guide groove 163 in the first direction Z may have a value corresponding to an angle θ1 formed by the first guide protrusion 143a in the first direction Z. The angle formed by the first guide groove 163 may have a value that may be the same as or substantially the same as the angle θ1 formed by the first guide protrusion 143a. Therefore, the first guide protrusion 143a may move downward while being inserted into the first guide groove 163.

An angle θa formed by the first inner side surface 162 in the first direction Z may have a value corresponding to an angle (03 of FIG. 6) formed by the first contact protrusion 142a in the first direction Z. Therefore, the first contact protrusion 142a may be in contact with the first inner side surface 162 of the lower case 161.

The lower case 161 may include a lower support portion 164 supporting the side plate 140. The lower support portion 164 may function as a stopper to prevent the side plate 140 from moving downward any further.

The second inner side surface 167 of the upper case 166 may have a slope. The slope of the second inner side surface 167 may have a shape in which a width of the accommodation space 160a decreases in an upward direction. The slope of the second inner side surface 167 may have a shape in which a width of the accommodation space 160a becomes narrower from a lower side to an upper side in the accommodation space 160a. For example, the upper accommodation space 166a of the upper case 166 may have a shape in which an upper side is narrower than a lower side.

The second guide groove 168 and the second guide protrusion 143b may have a shape having a slope in the first direction Z and extending upward, respectively. The slopes of the second guide groove 168 and the second guide protrusion 143b may correspond to the slope of the second inner side surface 167, respectively.

An angle formed by the second guide groove 168 in the first direction Z may have a value corresponding to an angle θ2 formed by the second guide protrusion 143b in the first direction Z. The angle formed by the second guide groove 168 may have a value equal to or substantially equal to the angle θ2 formed by the second guide protrusion 143b. Therefore, the second guide groove 168 may move downward along the second guide protrusion 143b.

An angle θb formed by the second inner side surface 167 in the first direction Z may have a value corresponding to an angle (04 in FIG. 6) formed by the second contact protrusion 142b in the first direction Z. Therefore, the second contact protrusion 142b may be in contact with the second inner side surface 167 of the upper case 166.

The transverse protrusion 144 of the side plate 140 may extend in a direction, intersecting the first direction Z. The transverse protrusion 144 may extend in the third direction X. The transverse protrusion 144 may be configured such that at least a portion thereof is in contact with the inner side surface of the module case 160. The transverse protrusion 144 opposing the lower case 161 may be in contact with the first inner side surface 162 of the lower case 161. The transverse protrusion 144 opposing the upper case 166 may be in contact with the second inner side surface 167 of the upper case 166.

When the transverse protrusion 144 is in contact with the module case 160, pressure due to swelling of the battery cell 121 may be uniformly transmitted to the module case 160 through the side plate 140. Therefore, structural stability and rigidity of the battery module 100 may be improved.

The lower case 161 and the upper case 166 may include the first coupling portion 165 and the second coupling portion 169, coupled to each other, respectively. The first coupling portion 165 may include the first accommodation groove 165a in which the lower portion of the sealing member 180 is seated, and the second coupling portion 169 may include the second accommodation groove 169a accommodating the upper portion of the sealing member 180. The sealing member 180 sealing the accommodation space 160a may be disposed in the first accommodation groove 165a and the second accommodation groove 169a.

A first heat transfer member 191 transferring heat generated in the cell assembly 120 to the lower case 161 may be disposed between the cell assembly 120 and the lower case 161. A second heat transfer member 192 transferring heat generated in the cell assembly 120 to the upper case 166 may be disposed between the cell assembly 120 and the upper case 166.

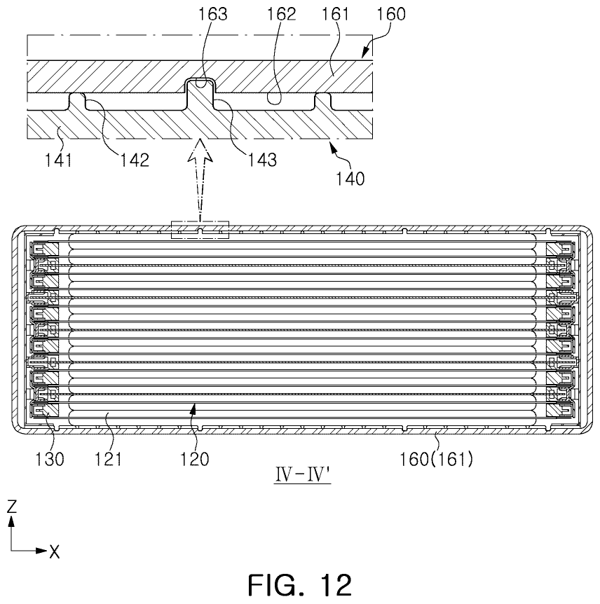

FIG. 12 is a cross-sectional view of a portion of the lower case 161 of FIG. 1, taken along line IV-IV′.

Referring to FIG. 12, the side plate 140 may include the guide protrusion 143 and the contact protrusion 142, protruding from the body 141. The guide protrusion 143 of the side plate 140 may be inserted into the first guide groove 163 of the lower case 161. The contact protrusion 142 of the side plate 140 may be in contact with the first inner side surface 162 of the lower case 161.

Although FIG. 12 illustrates the lower case 161, the guide protrusion 143 of the side plate 140 may be inserted into the second guide groove 168 of the upper case 166, and the contact protrusion 142 of the side plate 140 may be in contact with the second inner side surface 167 of the upper case 166.

As described above, the sub-module 110 may be formed by integrally coupling the side plate 140 and the cell assembly 120, and the sub-module may be accommodated in the lower case 161. In this case, the sub-module 110 may be coupled to the lower case 161, in a state in which the guide protrusion 143 of the side plate 140 is inserted into the first guide groove 163 of the lower case 161. The upper case 166 may cover the sub-module 110 in a state in which the sub-module 110 is coupled to the lower case 161. In this case, the second guide groove 168 of the upper case 166 may be coupled to the lower case 161 in a state accommodating the guide protrusion 143 of the side plate 140. Therefore, according to an embodiment, assembly of the battery module 100 may be easy.

In addition, according to an embodiment, since the guide protrusion 143 of the side plate 140 may be coupled to the first guide groove 163 of the lower case 161 and the second guide groove 168 of the upper case 166, bolt fastening may not be essential. Therefore, since the sealing member 180 does not need to have a shape avoiding a specific region such as a bolt fastening region or the like, sealability of the module case 160 may be improved.

According to the embodiment, since the contact protrusion 142 and/or the transverse protrusion 144 of the side plate 140 are in contact with the first inner side surface 162 of the lower case 161 and the second inner side surface 167 of the upper case 166, pressing force generated in the cell assembly 120 may be uniformly transmitted to the module case 160. Therefore, structural stability and rigidity of the battery module 100 may be improved.

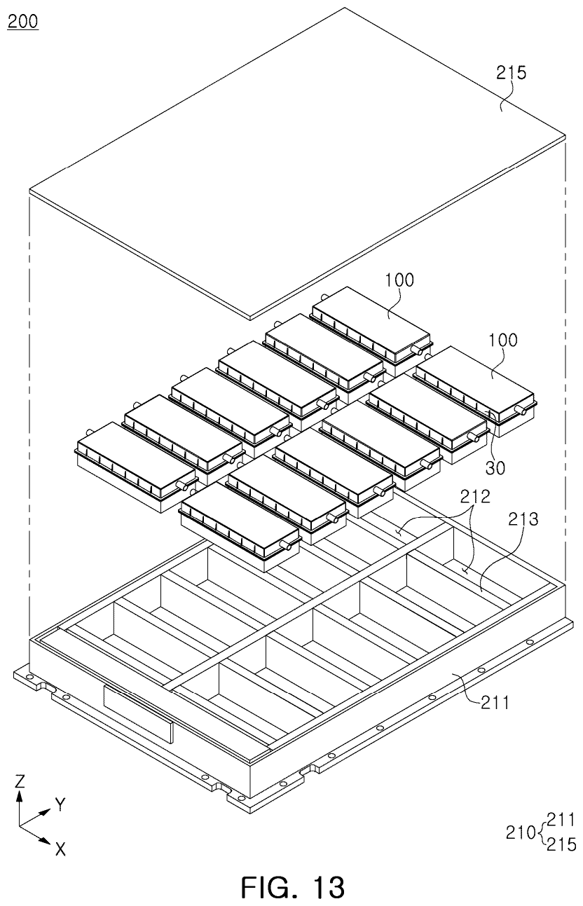

FIG. 13 is a perspective view of a battery pack 200 according to an embodiment.

Referring to FIG. 13, a battery pack 200 according to an embodiment may include a pack housing 210 including a plurality of battery modules 100 and a module accommodation space 212 accommodating the plurality of battery modules 100. A configuration of the battery module 100 described with reference to FIGS. 1 to 12 may be applied to a battery module 100 of FIG. 13.

The pack housing 210 may accommodate the plurality of battery modules 100. The pack housing 210 may include a housing body 211 including the module accommodation space 212, and a pack cover 215 covering the housing body 211. The housing body 211 may include a bulkhead 213 crossing the module accommodation space 212. The module accommodation space 212 of the pack housing 210 may be partitioned into a plurality of spaces by the bulkhead 213. The bulkhead 213 may partition a space in which the plurality of battery modules 100 are accommodated, and may block or prevent at least a portion of flame or gas generated from a single battery module 100 from spreading to an adjacent battery module 100.

According to an embodiment of the present disclosure, assembly of a battery module may be easy.

According to an embodiment of the present disclosure, structural stability and/or rigidity of a battery module may be improved.

According to an embodiment of the present disclosure, sealability of a battery module may be improved.

Only specific examples of implementations of certain embodiments may be described. Variations, improvements and enhancements of the disclosed embodiments and other embodiments may be made based on the disclosure of this patent document.

What is claimed is:

1. A battery module comprising:
a cell assembly including a plurality of battery cells;
a module case forming an accommodation space accommodating the cell assembly, and including a lower case and an upper case coupled to the lower case; and
a side plate disposed between the cell assembly and the module case,
wherein the lower case includes a first inner side surface opposing the side plate and having a slope in a first direction, a vertical direction, and a first guide groove recessed on the first inner side surface, and
the side plate includes a first guide protrusion inserted into and guided by the first guide groove.

2. The battery module of claim 1, wherein a slope of the first inner side surface has a shape in which a width of the accommodation space decreases in a downward direction, and
the first guide groove and the first guide protrusion have a shape having a slope in the first direction and extending in the downward direction, respectively, and
the cell assembly and the side plate are installed in the lower case, in a state in which the sub-module is formed.

3. The battery module of claim 2, wherein an angle formed by the first guide groove in the first direction has a value corresponding to an angle formed by the first guide protrusion in the first direction.

4. The battery module of claim 1, wherein the first guide groove and the first guide protrusion have a shape in which a width thereof decreases downward in the first direction, respectively.

5. The battery module of claim 1, wherein the plurality of battery cells and the side plate are arranged in a second direction, and
the first inner side surface of the lower case opposes the side plate in the second direction.

6. The battery module of claim 1, wherein the side plate further includes a first contact protrusion in which at least a portion of the side plate is in contact with the first inner side surface, and having a shape having a slope in the first direction and extending in a downward direction.

7. The battery module of claim 6, wherein an angle formed by the first inner side surface in the first direction has a value corresponding to an angle formed by the first contact protrusion in the first direction.

8. The battery module of claim 6, wherein the side plate further includes a transverse protrusion extending in a direction, intersecting the first direction, and
at least a portion of the transverse protrusion is in contact with the first inner side surface.

9. The battery module of claim 1, wherein the lower case further includes a lower support portion contacting a lower portion of the side plate and supporting the side plate.

10. The battery module of claim 1, wherein the upper case includes a second inner side surface opposing the side plate and having a slope in the first direction, and a second guide groove recessed in the second inner side surface, and
the side plate further includes a second guide protrusion inserted into and guided by the second guide groove.

11. The battery module of claim 10, wherein a slope of the second inner side surface has a shape in which a width of the accommodation space decreases in an upward direction, and
the second guide groove and the second guide protrusion have a shape having a slope in the first direction and extending in the upward direction, respectively.

12. The battery module of claim 10, wherein the first guide protrusion and the second guide protrusion have a symmetrical shape with respect to a plane, perpendicular to the first direction.

13. The battery module of claim 10, wherein the second guide groove and the second guide protrusion have a shape in which a width thereof decreases upwardly in the first direction, respectively.

14. The battery module of claim 10, wherein the side plate further includes a second contact protrusion in which at least a portion of the side plate is in contact with the second inner side surface, and having a shape having a slope in the first direction and extending in an upward direction.

15. The battery module of claim 10, wherein the side plate further includes a transverse protrusion extending in a direction, intersecting the first direction, and
at least a portion of the transverse protrusion is in contact with the second inner side surface.

16. The battery module of claim 10, wherein the lower case and the upper case include a first coupling portion and a second coupling portion, coupled to each other, respectively,
a sealing member sealing the accommodation space is disposed between the first coupling portion and the second coupling portion, and
the sealing member has a tetragonal ring shape having four straight portions extending in a straight line, respectively.

17. The battery module of claim 1, further including a busbar assembly electrically connected to the plurality of battery cells,
wherein the cell assembly, the busbar assembly, and the side plate are integrally coupled to form a sub-module,
the side plate includes a guide protrusion inserted into and guided by the guide groove.

18. The battery module of claim 1, wherein the accommodation space accommodates a refrigerant contacting the cell assembly to cool the cell assembly, and
the module case further includes a refrigerant inlet supplying the refrigerant to the accommodation space, and a refrigerant outlet discharging the refrigerant from the accommodation space.

19. A battery module comprising:
a cell assembly including a plurality of battery cells;
a module case forming an accommodation space accommodating the cell assembly, and including a lower case and an upper case coupled to the lower case; and
a side plate disposed between the cell assembly and the module case,
wherein at least one of the lower case or the upper case includes an inner side surface having a slope in a first direction, a vertical direction, and a guide groove recessed on the inner side surface, and

20. A battery pack comprising:
a plurality of battery modules; and
a pack housing including a module accommodation space accommodating the plurality of battery modules,
wherein at least one battery module among the plurality of battery modules includes:
a cell assembly including a plurality of battery cells;
a module case forming an accommodation space accommodating the cell assembly, and including a lower case and an upper case coupled to the lower case; and
a side plate disposed between the cell assembly and the module case,
wherein the lower case includes a first inner side surface opposing the side plate and having a slope in a first direction, a vertical direction, and a first guide groove recessed on the first inner side surface, and
the side plate includes a first guide protrusion inserted into and guided by the first guide groove.
